(19) United States
(12) Patent Application Publication
(10) Pub. No.: US 2023/0352229 A1
(43) Pub. Date: Nov. 2, 2023

(54) INDUCTOR AND MANUFACTURING METHOD THEREOF

(71) Applicant: POINT ENGINEERING CO., LTD., Asan-si (KR)

(72) Inventors: Bum Mo AHN, Suwon-si (KR); Seung Ho PARK, Hwaseong-si (KR); Tae Hwan SONG, Yongin-si (KR)

(21) Appl. No.: 18/298,936

(22) Filed: Apr. 11, 2023

(30) Foreign Application Priority Data
Apr. 29, 2022 (KR) 10-2022-0053194

(51) Int. Cl. H01F 27/28; H01F 27/29; H01F 41/04

(52) U.S. Cl. CPC H01F 27/2804; H01F 27/29; H01F 41/041; H01F 2027/2809

(57) ABSTRACT

Proposed are an inductor and a manufacturing method thereof. More particularly, proposed are an inductor capable of mass production by simplifying the manufacturing process while satisfying the needs for miniaturization and low resistance, and a manufacturing method thereof.

### CROSS REFERENCE TO RELATED APPLICATION

The present application claims priority to Korean Patent Application No. 10-2022-0053194, filed Apr. 29, 2022, the entire contents of which is incorporated herein for all purposes by this reference.

### BACKGROUND OF THE INVENTION

### Field of the Invention

The present disclosure relates to an inductor and a manufacturing method thereof.

### Description of the Related Art

Inductors are passive components that use the action of electromagnetic induction generated by applying current to conductive wires wound around a core. Various inductors are being developed for high-frequency circuits, general circuits, decoupling circuits, and power supply circuits.

Although there are variable inductors with varying inductance, most inductors are fixed inductors. The inductors are classified into lead type and surface mount type in terms of shape, and are classified into winding type, laminated type, and thin film type in terms of structure.

An inductor may be combined with a capacitor to form a resonant circuit, may be used in a filter circuit to filter signals of a specific type, or may be used for impedance matching.

With the recent development of electronic and communication devices, problems such as environmental issues and communications failures have arisen. Therefore, technology of electronic and communication devices is developing in terms of function complexity, high integration, and high efficiency.

As electronic and communications devices are becoming compact and highly efficient, it is required to suppress heat generation by reducing the size and resistance of used parts or devices. Thus, there is a need for research on how to reduce the size and resistance of inductors used in electronic and communications devices.

A winding type inductor is generally manufactured by the following process: A conductive wire is thermally fused to maintain a winding shape and wound to form a coil device part, the coil device part is embedded in a magnetic core in the form of a slurry, and the magnetic core is pressed and hardened.

A thin film type inductor is generally manufactured by the following process: A support member is prepared, a conductive layer is formed on upper and lower surfaces of the support member and patterned to form a coil pattern, and a magnetic sheet is stacked on the conductive layer and pressed and hardened to form a magnetic body.

A laminated type inductor is generally manufactured by the following process: A ceramic sheet is punched with a laser to form a via, multiple ceramic sheets on which conductor patterns are printed with conductive metal are stacked to fill the via, and the stacked sheets are sintered and integrated.

However, the structure of the inductor manufactured through the above manufacturing process has limits in satisfying the needs for miniaturization and low resistance required by the market, and mass production of the inductor is difficult due to the complicated manufacturing process.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent Application Publication No. 10-2020-0115286
(Patent document) Korean Patent No. 10-2093558

### SUMMARY OF THE INVENTION

Accordingly, the present disclosure has been made keeping in mind the above problems occurring in the related art, and an objective of the present disclosure is to provide an inductor capable of mass production by simplifying the manufacturing process while satisfying the needs for miniaturization and low resistance, and to provide a manufacturing method thereof.

In order to achieve the above objective, according to one aspect of the present disclosure, there is provided an inductor including: a body made of a low dielectric constant material; a coil part provided in the body, and including a plurality of vertical connection portions embedded in the body and a plurality of horizontal connection portions embedded in the body and connecting the plurality of vertical connection portions to each other; and first and second terminals connected to a first end and a second end of the coil part, respectively.

The coil part may further include: a first terminal connection portion connected to a horizontal connection portion located closest to the first end of the coil part among the plurality of horizontal connection portions, and forming the first end of the coil part; and a second terminal connection portion connected to a horizontal connection portion located closest to the second end of the coil part among the plurality of horizontal connection portions, and forming the second end of the coil part.

The first terminal may be provided on a left surface of the body and is electrically connected to the first terminal connection portion in a state in which a first end of the first terminal connection portion is in contact with an inner surface of the first terminal, and the second terminal may be provided on a right surface of the body and is electrically connected to the second terminal connection portion in a state in which a second end of the second terminal connection portion is in contact with an inner surface of the second terminal.

The horizontal connection portions may include: a plurality of upper horizontal connection portions connecting upper surfaces of the plurality of vertical connection portions; and a plurality of lower horizontal connection portions connecting lower surfaces of the plurality of vertical connection portions.

The vertical connection portions may include: a plurality of front vertical connection portions disposed at a front side of the body in a column direction; and a plurality of rear vertical connection portions disposed at a rear side of the body in the column direction, wherein when the front vertical connection portions are projected toward the rear vertical connection portions, the front vertical connection portions may be located between the rear vertical connection portions.

Each of the upper horizontal connection portions may connect any one front vertical connection portion among the plurality of front vertical connection portions and a rear vertical connection portion that is closest to the vertical connection portion among the plurality of rear vertical connection portions.

A plurality of fine trenches extending in a vertical direction may be provided on an outer circumferential surface of each of the plurality of vertical connection portions.

The vertical connection portions and the horizontal connection portions may have the same cross-sectional area.

The vertical connection portions and the horizontal connection portions may have a rectangular cross-section.

The body may be made of any one low dielectric constant material selected from the group consisting of silicon dioxide (SiO₂), cyclic olefin polymer (COP), fluorinated silicon oxide (SiOF), polyimides, parylene, fluorinated parylene, benzocyclobutene, and Teflon.

According to another aspect of the present disclosure, there is provided a manufacturing method of an inductor, the manufacturing method including: a preparation step of preparing a mold made of an anodic aluminum oxide film; a vertical through-hole forming step of forming a plurality of front vertical through-holes disposed at a front side of the mold in a column direction while penetrating upper and lower surfaces of the mold, and a plurality of rear vertical through-holes disposed at a rear side of the mold in the column direction while penetrating the upper and lower surfaces of the mold; a vertical connection portion forming step of forming a plurality of front vertical connection portions and a plurality of rear vertical connection portions by filling each of the plurality of front vertical through-holes and the plurality of rear vertical through-holes with an electrically conductive material; a horizontal connection portion forming step of forming a plurality of upper horizontal connection portions connecting upper surfaces of the plurality of front vertical connection portions and upper surfaces of the plurality of rear vertical connection portions at an upper side of the mold, and a plurality of lower horizontal connection portions connecting lower surfaces of the plurality of front vertical connection portions and lower surfaces of the plurality of rear vertical connection portions at a lower side of the mold; a mold removing step of removing the mold so that only a coil part formed by connecting the plurality of front and rear vertical connection portions and the plurality of upper and lower horizontal connection portions remains; and a body forming step of forming a body made of a low dielectric constant material and having the coil part embedded therein by entirely molding the coil part with a low dielectric constant material.

In the horizontal connection portion forming step, a first terminal connection portion connected to a horizontal connection portion located closest to a first end of the coil part among the plurality of horizontal connection portions and forming the first end of the coil part may be formed, and a second terminal connection portion connected to a horizontal connection portion located closest to a second end of the coil part among the plurality of horizontal connection portions and forming the second end of the coil part may be formed.

The manufacturing method may further include, after the body forming step, a terminal forming step of forming the first terminal provided on a left surface of the body and electrically connected to the first terminal connection portion in a state in which a first end of the first terminal connection portion is in contact with an inner surface of the first terminal, and a second terminal provided on a right surface of the body and electrically connected to the second terminal connection portion in a state in which a second end of the second terminal connection portion is in contact with an inner surface of the second terminal.

According to the inductor and the manufacturing method thereof according to the present disclosure as described above, the following effects are obtained.

Through the use of the mold made of the anodic aluminum oxide film, the vertical connection portions and the horizontal connection portions can be formed to have the same width or the same area. Thus, a stable current flow can be secured.

In addition, since thermal deformation of the inductor can be minimized, a coil of the coil part can be prevented from being broken or the inductance thereof can be prevented from being changed.

In addition, since the vertical through-holes are formed by wet etching, there is no possibility of thermal stress, so that the vertical through-holes can be formed densely. Therefore, the width of the vertical connection portions can be reduced, thereby greatly improving the inductance of the inductor.

In addition, a high aspect ratio and a fine pitch of the vertical connection portions can be ensured, thereby improving the inductance of the inductor.

In addition, since the coil part is embedded inside the low dielectric constant material, the loss of the inductor can be minimized, thereby ensuring a high quality factor of the inductor.

### BRIEF DESCRIPTION OF THE DRAWINGS

The above and other objects, features, and other advantages of the present disclosure will be more clearly understood from the following detailed description when taken in conjunction with the accompanying drawings, in which:

FIG. 1 is a view illustrating an inductor according to the present disclosure;

FIGS. 2A, 2B, 3A, 3B, 4A, 4B, 5A, 5B, 5C, 6A, 6B, 6C, 7A, and 7B are views illustrating a process of manufacturing the inductor according to the present disclosure; and

FIG. 8 is a schematic view illustrating a manufacturing method of the inductor according to the present disclosure.

### DETAILED DESCRIPTION OF THE INVENTION

Contents of the description below merely exemplify the principle of the present disclosure. Therefore, those of ordinary skill in the art may implement the theory of the present disclosure and invent various apparatuses which are included within the concept and the scope of the present disclosure even though it is not clearly explained or illustrated in the description. Furthermore, in principle, all the conditional terms and embodiments listed in this description are clearly intended for the purpose of understanding the concept of the present disclosure, and one should understand that the present disclosure is not limited to the exemplary embodiments and the conditions.

The above-described objectives, features, and advantages will be more apparent through the following detailed description related to the accompanying drawings, and thus those of ordinary skill in the art may easily implement the technical spirit of the present disclosure.

The embodiments of the present disclosure will be described with reference to cross-sectional views and/or perspective views which schematically illustrate ideal embodiments of the present disclosure. For explicit and convenient description of the technical content, sizes or thicknesses of films and regions in the figures may be exaggerated. Therefore, variations from the shapes of the illustrations as a result, for example, of manufacturing techniques and/or tolerances, are to be expected. In addition, a limited number of molded products are illustrated in the drawings. Thus, the embodiments should not be construed as limited to the particular shapes of regions illustrated herein but are to include deviations in shapes that result, for example, from manufacturing.

Wherever possible, the same reference numerals will be used throughout different embodiments and the description to refer to the same or like elements or parts. In addition, the configuration and operation already described in other embodiments will be omitted for convenience.

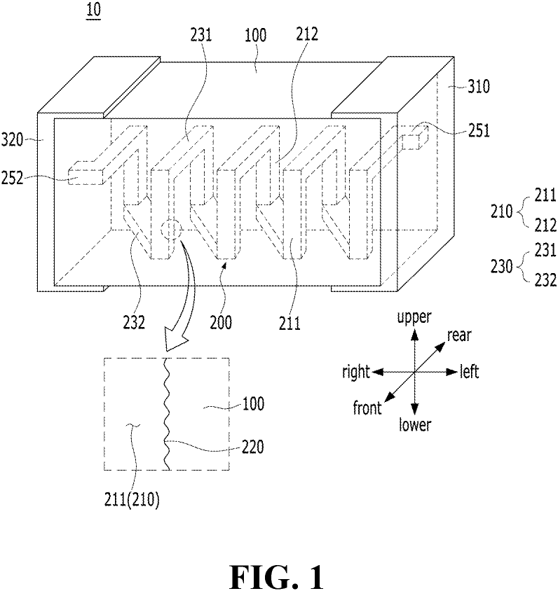

Hereinafter, an inductor 10 and a manufacturing method of the inductor 10 according to the present disclosure will be described with reference to FIGS. 1 to 8.

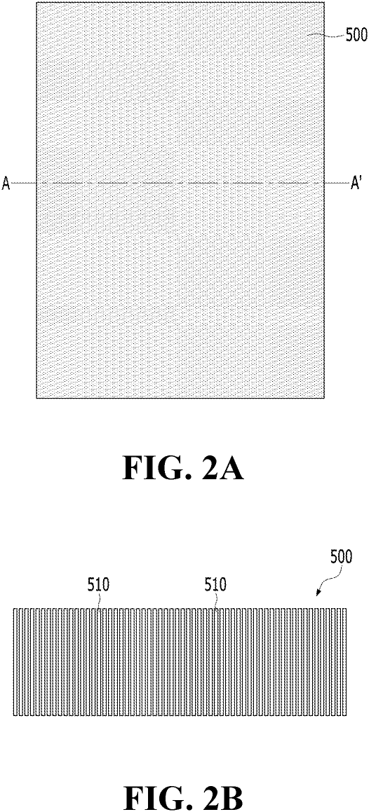

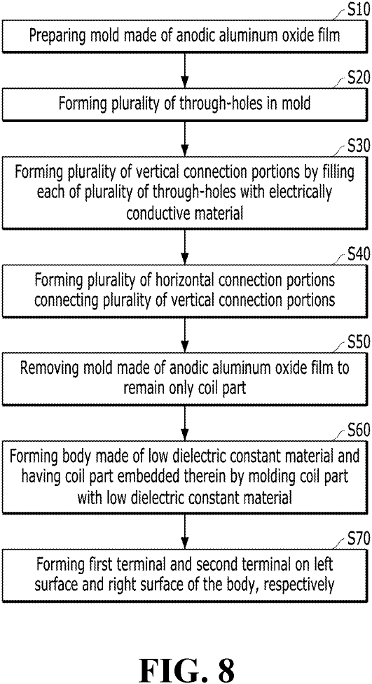

FIG. 1 is a view illustrating the inductor 10 according to the present disclosure; FIGS. 2A to 7B are views illustrating a process of manufacturing the inductor 10 according to the present disclosure; and FIG. 8 is a schematic view illustrating a manufacturing method of the inductor 10 according to the present disclosure.

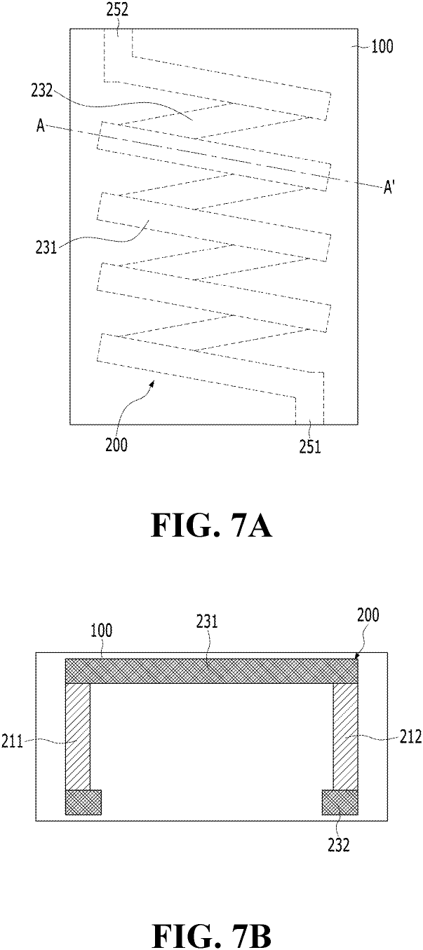

In FIG. 7A, which is a plan view, the upper direction is the left direction of the inductor 10, and the lower direction is the right direction of the inductor 10.

As illustrated in FIGS. 1 to 7B, the inductor 10 includes a body 100 made of a low dielectric constant material; a coil part 200 embedded in the body 100; and first and second terminals 310 and 320 connected to first and second ends of the coil part 200.

The body 100 may be made of a low dielectric constant material having a dielectric constant of equal to or less than 4.

For example, the body 100 may be made of any one low dielectric constant material selected from the group consisting of silicon dioxide (SiO₂), cyclic olefin polymer (COP), fluorinated silicon oxide (SiOF), polyimides, parylene, fluorinated parylene, benzocyclobutene, and Teflon.

The coil part 200 is embedded in the body 100.

The first terminal 310 is provided on a left surface of the body 100, and the second terminal 320 is provided on a right surface of the body 100.

A first end of a first terminal connection portion 251 constituting a first end of the coil part 200 is exposed externally on the left surface of the body 100. Therefore, the left surface of the body 100 and the first end of the first terminal connection portion 251 are simultaneously in contact with an inner surface of the first terminal 310 provided on the left surface of the body 100, that is, a right surface of the first terminal 310. As such, as the first end of the first terminal connection portion 251 and the inner surface (i.e., the right surface) of the first terminal 310 are in contact with each other, the first terminal connection portion 251 and the first terminal 310 are electrically connected to each other.

A second end of a second terminal connection portion 252 constituting a second end of the coil part 200 is exposed externally on the right surface of the body 100. Therefore, the right surface of the body 100 and the second end of the second terminal connection portion 252 are simultaneously in contact with an inner surface of the second terminal 320 provided on the right surface of the body 100, that is, a left surface of the second terminal 320. As such, as the second end of the second terminal connection portion 252 and the inner surface (i.e., the left surface) of the second terminal 320 are in contact with each other, the second terminal connection portion 252 and the second terminal 320 are electrically connected to each other.

The coil part 200 is embedded in the body 100.

When the first end of the coil part 200 is placed on the left surface and the second end of the coil part 200 is placed on the right surface, the left-to-right length of the coil part 200, that is, the horizontal length from the first end to the second end of the coil part 200, is equal to the left-to-right length of the body 100. Therefore, in this case, the first end and the second end of the coil part 200 are exposed externally together with the left and right surfaces of the body 100, respectively.

The coil part 200 includes: a plurality of vertical connection portions 210 embedded in the body 100; a plurality of horizontal connection portions 230 embedded in the body 100 and connecting the plurality of vertical connection portions 210; the first terminal connection portion 251 connected to a horizontal connection portion 230 located closest to the first end of the coil part 200 among the plurality of horizontal connection portions 230 and forming the first end of the coil part 200; and the second terminal connection portion 252 connected to a horizontal connection portion 230 located closest to the second end of the coil part 200 among the plurality of horizontal connection portions 230 and forming the second end of the coil part 200.

The plurality of horizontal connection portions 230 include: a plurality of upper horizontal connection portions 231 connecting upper surfaces of the plurality of vertical connection portions 210; and a plurality of lower horizontal connection portions 232 connecting lower surfaces of the plurality of vertical connection portions 210.

The vertical connection portions 210 are made of an electrically conductive material.

The horizontal connection portions 230 are made of an electrically conductive material, and may be made of the same material as the vertical connection portions 210.

The plurality of vertical connection portions 210 include: a plurality of front vertical connection portions 211 disposed at a front side of the body 100 in the column direction; and a plurality of rear vertical connection portions 212 disposed at a rear side of the body 100 in the column direction.

The plurality of front vertical connection portions 211 and the plurality of rear vertical connection portions 212 are alternately disposed in the column direction. Therefore, when the plurality of front vertical connection portions 211 are projected toward the plurality of rear vertical connection portions 212, the plurality of front vertical connection portions 211 are located between the plurality of rear vertical connection portions 212.

The plurality of front vertical connection portions 211 disposed in the column direction are spaced apart from each other by a predetermined distance. Also, the plurality of rear vertical connection portions 212 disposed in the column direction are spaced apart from each other by a predetermined distance.

Each of the upper horizontal connection portions 231 connects any one front vertical connection portion 211 among the plurality of front vertical connection portions 211 and a rear vertical connection portion 212 that is closest to the vertical connection portion 211 among the plurality of rear vertical connection portions 212.

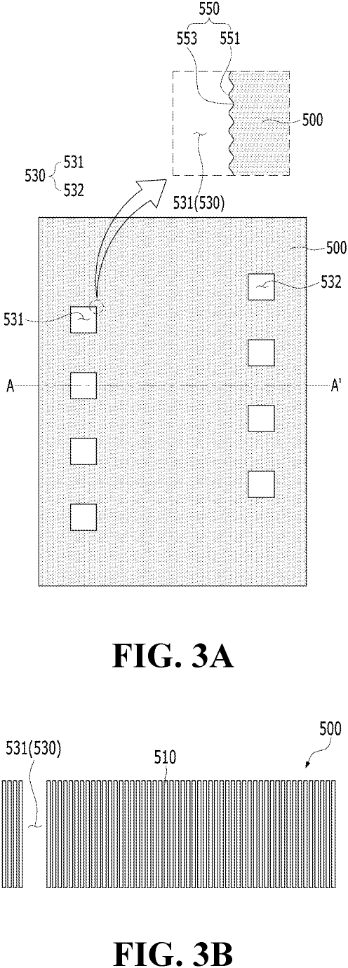

As illustrated in FIGS. 3A, 4A, and 5A, the upper horizontal connection portions 231 may be provided obliquely so as to have an upward-left slope.

The vertical connection portions 210 disposed in the column direction, that is, the plurality of front and rear vertical connection portions 211 and 212, are spaced apart from each other, respectively, by predetermined distances. Therefore, the upper horizontal connection portions 231 may have the same angle of slope.

Each of the lower horizontal connection portions 232 connects any one rear vertical connection portion 212 among the plurality of rear vertical connection portions 212 and a front vertical connection portion 211 that is closest to the rear vertical connection portion 212 among the plurality of front vertical connection portions 211.

As illustrated in FIGS. 3A, 4A, and 5A, the lower horizontal connection portions 232 may be provided obliquely so as to have an upward-right slope. The lower horizontal connection portions 232 may have the same angle of slope.

The upper horizontal connection portions 231 connect upper surfaces of the front and rear vertical connection portions 211 and 212 to each other. For example, each of the upper horizontal connection portions 231 connects an upper surface of any one front vertical connection portion 211 among the plurality of front vertical connection portions 211 and an upper surface of a rear vertical connection portion 212 that is closest to the vertical connection portion 211 among the plurality of rear vertical connection portions 212. In addition, each of the lower horizontal connection portions 232 connects a lower surface of any one rear vertical connection portion 212 among the plurality of rear vertical connection portions 212 and a lower surface of a front vertical connection portion 211 that is closest to the rear vertical connection portion 212 among the plurality of front vertical connection portions 211.

The upper horizontal connection portions 231 and the lower horizontal connection portions 232 are connected to each other through the front vertical connection portions 211 and the rear vertical connection portions 212 so as to form a winding shape.

When the plurality of front vertical connection portions 211 are projected toward the plurality of rear vertical connection portions 212, the plurality of front vertical connection portions 211 are located between the plurality of rear vertical connection portions 212.

Thus, when two adjacent front vertical connection portions 211 among the plurality of front vertical connection portions 211 are projected toward a rear vertical connection portion 212 located therebetween, the imaginary lines connecting the front and rear vertical connection portions 211 and 212 corresponds to the equal sides of an isosceles triangle. With this structure, the difference between the direction of magnetic flux generated by the lower horizontal connection portions 232 and the direction of magnetic flux generated by the upper horizontal connection portions 231 can be minimized, thereby obtaining stable inductance.

In addition, the upper horizontal connection portions 231 and the lower horizontal connection portions 232 have the same lengths so that the time current flows through the upper horizontal connection portions 231 is equal to the time current flows through the lower horizontal connection portions 232. With this structure, stable inductance can be obtained.

A terminal connection portion includes the first terminal connection portion 251 and the second terminal connection portion 252.

The first terminal connection portion 251 is connected to the horizontal connection portion 230 located closest to the first end of the coil part 200 among the plurality of horizontal connection portions 230, and forms the first end of the coil part 200.

As an example, in FIGS. 1 and 5A to 7C, the first terminal connection portion 251 is connected to an upper horizontal connection portion 231 located closest to the first end of the coil part 200 among the plurality of upper horizontal connection portions 231. In other words, the first terminal connection portion 251 is connected to the upper horizontal connection portion 231 located closest to the left surface of the body 100 among the plurality of upper horizontal connection portions 231.

The second terminal connection portion 252 is connected to the horizontal connection portion 230 located closest to the second end of the coil part 200 among the plurality of horizontal connection portions 230, and forms the second end of the coil part 200.

As an example, in FIGS. 1 and 5A to 7C, the second terminal connection portion 252 is connected to an upper horizontal connection portion 231 located closest to the second end of the coil part 200 among the plurality of upper horizontal connection portions 231. In other words, the second terminal connection portion 252 is connected to the upper horizontal connection portion 231 located closest to the right surface of the body 100 among the plurality of upper horizontal connection portions 231.

The first terminal 310 is provided on the left surface of the body 100.

The first terminal 310 has a substantially “]” shape surrounding the left surface of the body 100, a part of an upper surface of the body 100, and a part of a lower surface of the body 100.

The inner surface of the first terminal 310 is in contact with the left surface of the body 100 and the first end of the first terminal connection portion 251 at the same time. Therefore, the first terminal 310 and the first terminal connection portion 251 are electrically connected, so that the first terminal 310 and the coil part 200 are electrically connected.

The second terminal 320 is provided on the right surface of the body 100.

The second terminal 320 has a substantially “[” shape surrounding the right surface of the body 100, a part of the upper surface of the body 100, and a part of the lower surface of the body 100.

The inner surface of the second terminal 320 is in contact with the right surface of the body 100 and the second end of the second terminal connection portion 252 at the same time. Therefore, the second terminal 320 and the second terminal connection portion 252 are electrically connected, so that the second terminal 320 and the coil part 200 are electrically connected.

Since the first terminal 310 and the second terminal 320 are provided to be exposed externally on the left and right surfaces of the body 100, respectively, the inductor 10 can be easily electrically connected to a substrate or the like through the first terminal 310 and the second terminal 320.

The terminal connection portion (i.e., the first and second terminal connection portions 251 and 252), the vertical connection portions 210 (i.e., the front vertical connection portions 211 and the rear vertical connection portions 212), and the horizontal connection portions 230 (i.e., the upper horizontal connection portions 231 and the lower horizontal connection portions 232) all preferably have the same cross-sectional area.

The terminal connection portion (i.e., the first and second terminal connection portions 251 and 252), the vertical connection portions 210 (i.e., the front vertical connection portions 211 and the rear vertical connection portions 212) and the horizontal connection portions 230 (i.e., the upper horizontal connection portions 231 and the lower horizontal connection portions 232 have a continuous winding shape to form the coil part 200. Thus, when terminal connection portion (i.e., the first and second terminal connection portions 251 and 252), the vertical connection portions 210 (i.e., the front vertical connection portions 211 and the rear vertical connection portions 212), and the horizontal connection portions 230 (i.e., the upper horizontal connection portions 231 and the lower horizontal connection portions 232) all have the same cross-sectional area, the occurrence of a bottleneck section caused by a difference in the cross-sectional area of the coil part 200 can be prevented, so that electricity can flow efficiently throughout the coil part 200, thereby ensuring high inductance of the inductor 10.

The terminal connection portion (i.e., the first and second terminal connection portions 251 and 252), the vertical connection portions 210 (i.e., the front vertical connection portions 211 and the rear vertical connection portions 212), and the horizontal connection portions 230 (i.e., the upper horizontal connection portions 231 and the lower horizontal connection portions 232) may have a rectangular cross-section, a square cross-section, or a circular cross-section.

As illustrated in FIG. 1, a plurality of fine trenches 220 extending in the height direction, that is, in the vertical direction, are provided on outer circumferential surfaces of the vertical connection portions 210 (i.e., the front vertical connection portions 211 and the rear vertical connection portions 212).

The plurality of fine trenches 220 are continuously and vertically formed on the outer circumferential surfaces of the vertical connection portions 210 (i.e., the front vertical connection portions 211 and the rear vertical connection portions 212).

The fine trenches 220 have a depth in the range of 20 nm to 1 µm and a width in the range of 20 nm to 1 µm.

Because the fine trenches 220 are resulted from the formation of pores 510 formed during the manufacture of a mold 500 made of an anodic aluminum oxide film which will be described later, the width and depth of the fine trenches 220 are equal or less than the diameter of the pores 510 of the mold 500.

The fine trenches 220 are vertically and regularly formed on the outer circumferential surfaces of the vertical connection portions 210 (i.e., the front vertical connection portions 211 and the rear vertical connection portions 212). The fine trenches 220 have a corrugated shape in which peaks and valleys with a depth in the range of 20 nm to 1 µm are repeated.

As the fine trenches 220 are formed on the outer circumferential surfaces of the vertical connection portions 210 (i.e., the front vertical connection portions 211 and the rear vertical connection portions 212), the contact area between the vertical connection portions 210 and the body 100 is widened by the corrugated shape of the fine trench 220. With this structure, when the coil part 200 is embedded in the body 100, the coupling between the vertical connection portions 210 and the body 100 can be firmly maintained. Therefore, even when vibration is generated in the inductor 10, the coil part 200 does not move inside the body 100.

The inductor 10 according to the present disclosure cannot obtain a high inductance value due to its low permeability because the body 100 is made of a material with a low dielectric constant, but it has a high quality factor value at high frequencies because its loss is relatively small. Therefore, the inductor 10 according to the present disclosure functions as a dielectric inductor having a high quality factor value due to the body 100 of a low dielectric constant material.

Hereinafter, a manufacturing method of an inductor 10 according to the present disclosure will be described.

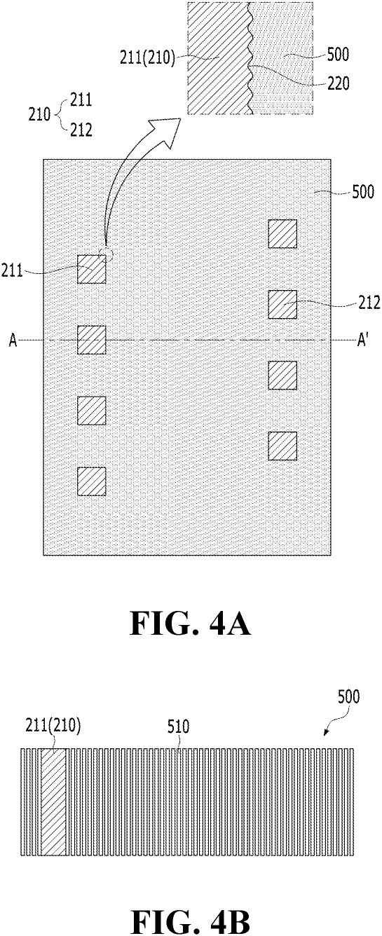

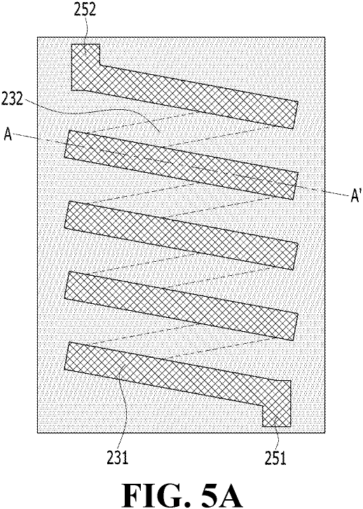

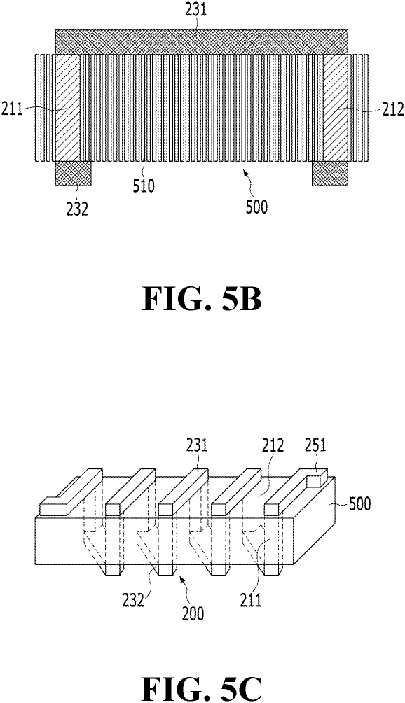

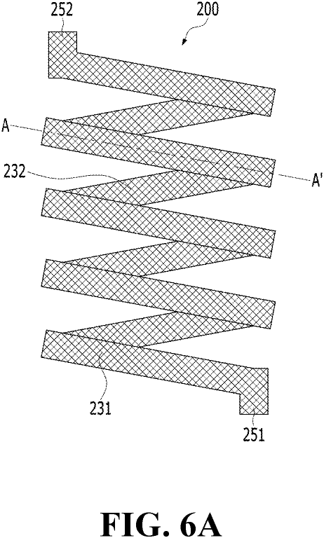

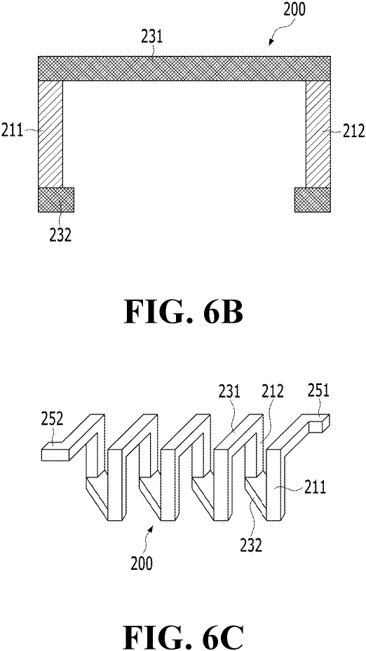

FIG. 2A is a plan view illustrating a mold 500 made of an anodic aluminum oxide film; FIG. 2B is a sectional view illustrating the mold 500 taken along line A-A′ of FIG. 2A; FIG. 3A is a plan view illustrating the mold in which front and rear vertical through-holes 531 and 532; FIG. 3B is a sectional view illustrating the mold 500 taken along line A-A′ of FIG. 3A; FIG. 4A is a plan view illustrating the mold 500 in which front and rear vertical connection portions 211 and 212 are formed; FIG. 4B is a sectional view illustrating the mold 500 taken along line A-A′ of FIG. 4A; FIG. 5A is a plan view illustrating the mold 500 in which upper and lower horizontal connection portions 231 and 232 and first and second terminal connection portions 251 and 252 are formed; FIG. 5B is a sectional view illustrating the mold 500 taken along line A-A′ of FIG. 5A; FIG. 5C is a perspective view of FIG. 5A; FIG. 6A is a plan view illustrating a coil part 200 in a state in which only the coil part 200 remains after the mold 500 is removed from the state of FIG. 5A; FIG. 6B is a sectional view illustrating the coil part 200 taken along A-A′ of FIG. 6A; FIG. 6C is a perspective view illustrating the coil part illustrated in FIG. 6A; FIG. 7A is a plan view illustrating the inductor 10 according to the present disclosure in which the coil part 200 illustrated in FIG. 6A is embedded in a body 100 made of a low dielectric constant material; and FIG. 7B is a sectional view illustrating the inductor 10 taken along line A-A′ of FIG. 7A.

As illustrated in FIGS. 2A to 8, the manufacturing method of the inductor 10 according to the present disclosure includes: a preparation step (S10) of preparing the mold 500 made of the anodic aluminum oxide film; a vertical through-hole forming step (S20) of forming a plurality of front vertical through-holes 531 disposed at a front side of the mold 500 in the column direction while penetrating upper and lower surfaces of the mold 500, and a plurality of rear vertical through-holes 532 disposed at a rear side of the mold 500 in the column direction while penetrating the upper and lower surfaces of the mold 500; a vertical connection portion forming step (S30) of forming a plurality of front vertical connection portions 211 and a plurality of rear vertical connection portions 212 by filling each of the plurality of front vertical through-holes 531 and the plurality of rear vertical through-holes 532 with an electrically conductive material; a horizontal connection portion forming step (S40) of forming a plurality of upper horizontal connection portions 231 connecting upper surfaces of the plurality of front vertical connection portions 211 and upper surfaces of the plurality of rear vertical connection portions 212 at an upper side of the mold 500, and a plurality of lower horizontal connection portions 232 connecting lower surfaces of the plurality of front vertical connection portions 211 and lower surfaces of the plurality of rear vertical connection portions 212 at a lower side of the mold 500; a mold removing step (S50) of removing the mold 500 so that only the coil part 200 formed by connecting the plurality of front and rear vertical connection portions 211 and 212, the plurality of upper and lower horizontal connection portions 231 and 232, and the first and second terminal connection portions 251 and 252 remains; a body forming step (S60) of forming the body 100 made of the low dielectric constant material and having the coil part 200 embedded therein by entirely molding the coil part 200 with the low dielectric constant material; and a terminal forming step (70) of forming a first terminal 310 provided on a left surface of the body 100 and electrically connected to the first terminal connection portion 251 in a state in which a first end of the first terminal connection portion 251 is in contact with an inner surface of the first terminal 310, and a second terminal 320 provided on a right surface of the body 100 and electrically connected to the second terminal connection portion 252 in a state in which a second end of the second terminal connection portion 252 is in contact with an inner surface of the second terminal 320.

As illustrated in FIGS. 2A and 2B, in the preparation step (S10), the mold 500 made of the anodic aluminum oxide film is prepared.

When a metal, which is a base material, is anodized, an anodic aluminum oxide film is formed. A plurality of pores 510 are formed inside the anodic aluminum oxide film.

After the anodic aluminum oxide film is formed on the metal, the base material is removed so that only the anodic aluminum oxide film remains. Then, when a barrier layer is removed so that only a porous layer in which the pores 110 are formed remains, the mold 500 composed of only the porous layer of the anodic aluminum oxide film is manufactured.

In the mold 500 from which the barrier layer is removed, only the anodic aluminum oxide film remains, and the plurality of pores 510 are provided. The plurality of pores 510 penetrate upper and lower surfaces of the mold 500 to form the porous layer.

As such, when the mold 500 is prepared, the preparation step (S10) is completed.

After the preparation step (S10) is completed, the vertical through-hole forming step (S20) is performed.

As illustrated in FIGS. 3A and 3B, in the vertical through-hole forming step (S20), the plurality of front vertical through-holes 531 disposed at the front side of the mold 500 in the column direction while penetrating the upper and lower surfaces of the mold 500 are formed, and the plurality of rear vertical through-holes 532 disposed at the rear side of the mold 500 in the column direction while penetrating the upper and lower surfaces of the mold 500 are formed.

That is, in the vertical through-hole forming step (S20), a plurality of vertical through-holes 530 penetrating the upper and lower surfaces of the mold 500 are formed. Here, the vertical through-holes 530 may include the front vertical through-holes 531 and the rear vertical through-holes 532 described above.

The vertical through-holes 530, that is, the front vertical through-holes 531 and the rear vertical through-holes 532 may have a square cross-section. Therefore, vertical connection portions 210, that is, the front vertical connection portions 211 and the rear vertical connection portions 212, formed by the vertical through-holes 530, that is, the front vertical through-holes 531 and the rear vertical through-holes 532, may have a cube shape with a square cross-section.

Unlike as illustrated in the drawings, the vertical through-holes 530, that is, the front vertical through-holes 531 and the rear vertical through-holes 532 may have a circular cross-section. Therefore, the vertical connection portions 210, that is, the front vertical connection portions 211 and the rear vertical connection portions 212, formed by the vertical through-holes 530, that is, the front vertical through-holes 531 and the rear vertical through-holes 532, may have a cylindrical shape with a circular cross section.

As illustrated in FIG. 3A, the plurality of front vertical through-holes 531 are formed at the front side of the mold 500, and the plurality of rear vertical through-holes 532 are formed at the rear side of the mold 500.

As the mold 500 is made of the anodic aluminum oxide film, the front and rear vertical through-holes 531 and 532 can be easily formed.

In the case of the inductor 10 according to the present disclosure, since the mold 500 is made of the anodic aluminum oxide film, the vertical through-holes 530, that is, the front and rear vertical through-holes 531 and 532, may be formed by wet etching using a photoresist patterned in the mold 500 made of the anodic aluminum oxide film. As a result, inner walls of the vertical through-holes 530, that is, the front and rear vertical through-holes 531 and 532, have a vertical shape. In other words, the inner walls of the vertical through-holes 530, that is, the front and rear vertical through-holes 531 and 532, can have a uniform cross-sectional area from the bottom to the top of the vertical through-holes 530, that is, the front and rear vertical through-holes 531 and 532. With this structure, the flow of current in the coil part 200 is stable.

In addition, since the vertical through-holes 530, that is, the front and rear vertical through-holes 531 and 532, are formed by wet etching, there is no possibility of thermal stress, so that the vertical through-holes 530, that is, the front and rear vertical through-holes 531 and 532, can be formed densely.

For example, when the width of the vertical connection portions 210 is reduced by half, the number of windings of the coil part 200 can be doubled, and as a result, the inductance of the inductor 10 can be quadrupled.

In the case of the inductor 10 according to the present disclosure, when the mold 500 is made of the anodic aluminum oxide film, the width of the vertical connection portions 210 can be reduced, thereby greatly improving the inductance of the inductor 10.

In the case of using a laser as in the related art, there is a limit in reducing the width of the vertical through-holes 530.

In the case of the present disclosure, when the mold 500 is made of the anodic aluminum oxide film and the vertical through-holes 530 are formed by wet etching the anodic aluminum oxide film, the vertical connection portions 210 can be formed to have a width of equal to or less than 10 µm. However, the width of the vertical connection portions 210 is preferably equal to or greater than 1 um because resistance to current flowing through the coil part 200 increases when the width of the vertical connection portions 210 is too small.

In addition, when the mold 500 is made of the anodic aluminum oxide film, since the vertical through-holes 530 are formed by wet etching the anodic oxide film, the vertical through-holes 530 can be formed to have a cross section other than a circular cross-section. Horizontal connection portions 230 have a predetermined height and have a rectangular cross-section. Since the vertical connection portions 210 can be formed to have a rectangular horizontal cross-section using wet etching, the horizontal connection portions 230 and the vertical connection portions 210 can be formed to have the same width. Also, the horizontal connection portions 230 and the vertical connection portions 210 can be formed to have the same cross-sectional area. It is preferable, in terms of securing a stable flow of the current flowing through the coil part 200, that the vertical connection portions 210 and the horizontal connection portions 230 are formed to have the same area. Therefore, since the vertical connection portions 210 and the horizontal connection portions 230 can be formed to have the same width or area when the mold 500 is made of the anodic aluminum oxide film, a stable current flow can be secured.

As such, when the plurality of front and rear vertical through-holes 531 and 532 are formed at the front and rear sides of the mold 500, respectively, the vertical through-hole forming step (S20) is completed.

The enlarged view of FIG. 3A illustrates a boundary surface 550 between the mold 500 and each of the vertical through-holes 530 (i.e., the front vertical through-holes 531 and the rear vertical through-holes 532).

Since a plurality of fine pores 510 are formed in the mold 500, when the vertical through-holes 530 (i.e., the front vertical through-holes 531 and the rear vertical through-holes 532) are formed in the mold 500 by etching, a plurality of valleys 553 are formed on the boundary surface 550 by the pores 510.

In addition, in the process of forming the vertical through-holes 530 (i.e., the front vertical through-holes 531 and the rear vertical through-holes 532) by etching, the valleys 553 formed by the pores 510 do not maintain their shape, so that a plurality of peaks 551 are formed between the plurality of valleys 553.

Therefore, the boundary surface 550 between the mold 500 and each of the vertical through-holes 530 (i.e., the front vertical through-holes 531 and the rear vertical through-holes 532) has a wave shape in which the peaks 551 and the valleys 553 are continuously formed.

After the vertical through-hole forming step (S20) is completed, the vertical connection portion forming step (S30) is performed.

As illustrated in FIGS. 4A and 4B, in the vertical connection portion forming step (S30), the plurality of front vertical connection portions 211 and the plurality of rear vertical connection portions 212 are formed by filling each of the plurality of front vertical through-holes 531 and the plurality of rear vertical through-holes 532 with the electrically conductive material.

That is, in the vertical connection portion forming step (S30), a plurality of vertical connection portions 210 are formed by filling each of the plurality of vertical through-holes 530 with the electrically conductive material.

The vertical connection portions 210 include the front vertical connection portions 211 disposed at the front side of the mold 500 in the column direction, and the rear vertical connection portions 212 disposed at the rear side of the mold 500 in the column direction.

The front and rear vertical connection portions 211 and 212 may be formed by filling the inside of each of the front and rear vertical through-holes 531 and 532 with the electrically conductive material using a plating method, a press-fitting method, or the like.

When the plurality of front and rear vertical connection portions 211 and 212 are formed by filling each of the plurality of front and rear vertical through-holes 531 and 532 with the electrically conductive material, the vertical connection portion forming step (S30) is completed.

The enlarged view of FIG. 4A illustrates a plurality of fine trenches 220 formed at the boundary between the mold 500 and each of the vertical connection portions 230 (i.e., the front vertical connection portions 211 and the rear vertical connection portions 212).

By the peaks 551 of the boundary surface 550 described above, the fine trenches 220 having a valley shape are formed on an outer circumferential surface of each of the vertical connection portions 230 (i.e., the front vertical connection portions 211 and the rear vertical connection portions 212). Therefore, a plurality of valleys are formed between the fine trenches 220 by the valleys 553 of the boundary surface 550.

The fine trenches 220 have a depth in the range of 20 nm to 1 µm and a width in the range of 20 nm to 1 µm.

Because the fine trenches 220 are resulted from the formation of pores 510 formed during the manufacture of the mold 500 made of the anodic aluminum oxide film, the width and depth of the fine trenches 220 are equal or less than the diameter of the pores 510 of the mold 500.

The fine trenches 220 are vertically and regularly formed on the outer circumferential surfaces of the vertical connection portions 210 (i.e., the front vertical connection portions 211 and the rear vertical connection portions 212). The fine trenches 220 have a corrugated shape in which peaks and valleys with a depth in the range of 20 nm to 1 µm are repeated.

After the vertical connection portion forming step (S30) is completed, the horizontal connection portion forming step (S40) is performed.

As illustrated in FIGS. 5A to 5C, in the horizontal connection portion forming step (S40), the plurality of upper horizontal connection portions 231 connecting the upper surfaces of the plurality of front vertical connection portions 211 and the upper surfaces of the plurality of rear vertical connection portions 212 at the upper side of the mold 500 are formed, and the plurality of lower horizontal connection portions 232 connecting the lower surfaces of the plurality of front vertical connection portions 211 and the lower surfaces of the plurality of rear vertical connection portions 212 at the lower side of the mold 500 are formed.

That is, in the horizontal connection portion forming step (S40), a plurality of horizontal connection portions 230 horizontally connecting the plurality of vertical connection portions 210 to each other are formed.

Here, the horizontal connection portions 230 include the plurality of upper horizontal connection portions 231 disposed at the upper side of the mold 500 and the plurality of lower horizontal connection portions 232 disposed at the lower side of the mold 500.

The upper horizontal connection portions 231 may be formed on an upper surface of the mold 500 using a known metal patterning method.

Each of the upper horizontal connection portions 231 connects an upper surface of any one front vertical connection portion 211 among the plurality of front vertical connection portions 211 and an upper surface of a rear vertical connection portion 212 that is closest to the vertical connection portion 211 among the plurality of rear vertical connection portions 212. Therefore, as illustrated in FIG. 5A, the upper horizontal connection portions 231 are provided obliquely so as to have an upward-left slope.

The upper horizontal connection portions 231 may have the same angle of slope.

The lower horizontal connection portions 232 may be formed on a lower surface of the mold 500 using a known metal patterning method.

Each of the lower horizontal connection portions 232 connects a lower surface of any one front vertical connection portion 211 among the plurality of front vertical connection portions 211 and a lower surface of a rear vertical connection portion 212 that is closest to the vertical connection portion 211 among the plurality of rear vertical connection portions 212. Therefore, as illustrated in FIG. 5A, the lower horizontal connection portions 232 are provided obliquely so as to have an upward-right slope.

The lower horizontal connection portions 232 may have the same angle of slope.

In the horizontal connection portion forming step (S40), the first terminal connection portion 251 connected to a horizontal connection portion 230 located closest to a first end of the coil part 200 among the plurality of horizontal connection portions 230 and forming the first end of the coil part 200 is formed, and the second terminal connection portion 252 connected to a horizontal connection portion 230 located closest to a second end of the coil part 200 among the plurality of horizontal connection portions 230 and forming the second end of the coil part 200 is formed.

The first terminal connection portion 251 extends from a first end of the horizontal connection portion 230 located closest to the first end of the coil part 200 among the plurality of horizontal connection portions 230.

In the present disclosure, as illustrated in FIG. 5A, the first terminal connection portion 251 extends from a first end of an upper horizontal connection portion 231 located closest to a first end of the mold 500, that is, located at the leftmost side, among the plurality of upper horizontal connection portions 231, so that the first terminal connection portion 251 is connected to the leftmost upper horizontal connection portion 231.

Unlike the above, the first terminal connection portion 251 may be connected to a first end of a lower horizontal connection portion 232 located closest to the first end of the coil part 200, that is, located at the leftmost side, among the plurality of lower horizontal connection portions 232.

The second terminal connection portion 252 extends from a first end of the horizontal connection portion 230 located closest to the second end of the coil part 200 among the plurality of horizontal connection portions 230.

In the present disclosure, as illustrated in FIG. 5A, the second terminal connection portion 252 extends from a second end of an upper horizontal connection portion 231 located closest to a second end of the mold 500, that is, located at the rightmost side, among the plurality of upper horizontal connection portions 231, so that the second terminal connection portion 252 is connected to the rightmost upper horizontal connection portion 231.

Unlike the above, the second terminal connection portion 252 may be connected to a second end of a lower horizontal connection portion 232 located closest to the second end of the coil part 200, that is, located at the rightmost side, among the plurality of lower horizontal connection portions 232.

The first terminal connection portion 251 and the second terminal connection portion 252 may be formed on the upper or lower surface of the mold 500 using a known metal patterning method.

As such, as the upper horizontal connection portions 231, the lower horizontal connection portions 232, the first terminal connection portion 251, and the second terminal connection portion 252 are formed, the front vertical connection portions 211, the rear vertical connection portions 212, the upper horizontal connection portions 231, and the lower horizontal connection portions 232 form the coil part 200 having a winding shape.

When the upper horizontal connection portions 231, the lower horizontal connection portions 232, the first terminal connection portion 251, and the second terminal connection portion 252 are formed, the horizontal connection portion forming step (S40) is completed.

After the horizontal connection portion forming step (S40) is completed, the mold removing step (S50) is performed.

As illustrated in FIGS. 6A to 6C, in the mold removing step (S50), the mold 500 is removed so that only the coil part 200 formed by connecting the plurality of front and rear vertical connection portions 211 and 212, the plurality of upper and lower horizontal connection portions 231 and 232, and the first and second terminal connection portions 251 and 252 remains.

In the mold removing step (S50), the mold 500 made of the anodic aluminum oxide film is wet-etched to remain only the coil part 200.

As such, when the mold 500 is removed, the mold removing step (S50) is completed.

After the mold removing step (S50) is completed, the body forming step (S60) is performed.

As illustrated in FIGS. 7A and 7B, in the body forming step (S60), the body 100 made of the low dielectric constant material and having the coil part 200 embedded therein is formed by entirely molding the coil part 200 with the low dielectric constant material.

The body 100 may be made of a low dielectric constant material having a dielectric constant of equal to or less than 4.

For example, the body 100 may be made of any one low dielectric constant material selected from the group consisting of silicon dioxide (SiO₂), cyclic olefin polymer (COP), fluorinated silicon oxide (SiOF), polyimides, parylene, fluorinated parylene, benzocyclobutene, and Teflon.

The coil part 200 may be embedded inside the body 100 by entirely molding the coil part 200.

When the body 100 is formed inside and outside the coil part 200, the body forming step (S60) is completed.

After the body forming step (S60) is completed, the terminal forming step (S70) is performed.

In the terminal forming step (S70), the first terminal 310 provided on the left surface of the body 100 and electrically connected to the first terminal connection portion 251 in a state in which the first end of the first terminal connection portion 251 is in contact with the inner surface of the first terminal 310 is formed, and the second terminal 320 provided on the right surface of the body 100 and electrically connected to the second terminal connection portion 252 in a state in which the second end of the second terminal connection portion 252 is in contact with the second terminal 320 is formed.

As illustrated in FIG. 1, the first terminal 310 is provided on the left surface of the body 100, and is formed in a shape surrounding a part of an upper surface of the body 100, a part of a lower surface of the body 100, and the left surface of the body 100.

The first terminal 310 may be formed on the upper, left, and lower surfaces of the body 100 using a known metal patterning method.

The second terminal 320 is provided on the right surface of the body 100, and is formed in a shape surrounding a part of the upper surface of the body 100, a part of the lower surface of the body 100, and the right surface of the body 100.

The second terminal 320 may be formed on the upper, right, and lower surfaces of the body 100 using a known metal patterning method.

When the formation of the first terminal 310 and the second terminal 320 is completed, manufacturing of the inductor 10 is completed.

According to the above-described manufacturing method of the inductor 10 according to the present disclosure, through the use of the mold 500 made of the anodic aluminum oxide film, the coil part 200 is formed by wet etching, patterning, etc. Thus, the manufacturing process can be simplified, thereby enabling mass production of the inductor 10.

Through the use of the mold 500 made of the anodic aluminum oxide film, the vertical connection portions 210 and the horizontal connection portions 230 can be formed to have the same width or the same area. Thus, a stable current flow can be secured.

In addition, since the vertical through-holes 530 are formed by wet etching, there is no possibility of thermal stress, so that the vertical through-holes 530 can be formed densely. Therefore, the width of the vertical connection portions 210 can be reduced, thereby greatly improving the inductance of the inductor 10.

In detail, in the case of the related art, since a coil part is formed using a photoresist etc., it is impossible to densely form vertical connection portions with a fine pitch because a distance has to be secured in an exposure process. However, in the case of the present disclosure, since the vertical connection portions 210 are formed through the vertical through-holes 530 of the mold 500 made of the anodic aluminum oxide film, the vertical connection portions 210 can be densely formed at a fine pitch in the range of 4 µm to 5 µm.

In addition, in the case of the related art, since the vertical connection portions are formed using a photoresist, etc., when the vertical connection portions need to be formed thick, photoresists have to be stacked in multiple layers. This results in a height difference between the multi-layered photoresists, thereby making it difficult to make the vertical connection portions high. However, in the case of the present disclosure, since the vertical connection portions 210 are formed through the vertical through-holes 530 of the mold 500 made of the anodic aluminum oxide film, the vertical connection portions 210 can be easily formed to have a high aspect ratio. The vertical connection portions 210 formed using the mold 500 made of the anodic aluminum oxide film according to the present disclosure may have a height in the range of 100 µm to 120 µm, and an aspect ratio of about 1:20.

As described above, by manufacturing the inductor 10 using the mold 500 made of the anodic aluminum oxide film according to the present disclosure, the vertical connection portions 210 of the coil part 200 can achieve a high aspect ratio and a fine pitch, so that the cross-sectional area and number of windings of the coil part 200 can be easily increased. Therefore, high inductance of the inductor 10 can be ensured.

Through the use of the mold 500 made of the anodic aluminum oxide film, the vertical connection portions 210 and the horizontal connection portions 230 can be formed to have the same rectangular or square cross-section, and also can be formed to have the same cross-sectional area. Therefore, the resistance of electricity flowing along the coil part 200 can be reduced, and high inductance of the inductor 10 can be ensured.

Since the coil part 200 is formed using the mold 500 made of the anodic aluminum oxide film, thermal deformation of the coil part 200 can be minimized. Therefore, a coil of the coil part 200 can be prevented from being broken or the inductance thereof can be prevented from being changed.

In addition, by manufacturing only the coil part 200 by removing the mold 500 made of the anodic aluminum oxide film and then forming the body 100 of the low dielectric constant material on the coil part 200, the coil part 200 can be easily embedded in the low dielectric constant material. With this structure, the inductor 10 according to the present disclosure can have a high quality factor.

As described above, the present disclosure has been described with reference to the exemplary embodiments. However, those skilled in the art will appreciate that various modifications, additions, and substitutions are possible, without departing from the scope and spirit of the present disclosure as disclosed in the accompanying claims.

What is claimed is:

1. An inductor comprising:
a body made of a low dielectric constant material;
a coil part provided in the body, and comprising a plurality of vertical connection portions embedded in the body and a plurality of horizontal connection portions embedded in the body and connecting the plurality of vertical connection portions to each other; and
first and second terminals connected to a first end and a second end of the coil part, respectively.

2. The inductor of claim 1, wherein the coil part further comprises:
a first terminal connection portion connected to a horizontal connection portion located closest to the first end of the coil part among the plurality of horizontal connection portions, and forming the first end of the coil part; and
a second terminal connection portion connected to a horizontal connection portion located closest to the second end of the coil part among the plurality of horizontal connection portions, and forming the second end of the coil part.

3. The inductor of claim 2, wherein the first terminal is provided on a left surface of the body and is electrically connected to the first terminal connection portion in a state in which a first end of the first terminal connection portion is in contact with an inner surface of the first terminal, and
the second terminal is provided on a right surface of the body and is electrically connected to the second terminal connection portion in a state in which a second end of the second terminal connection portion is in contact with an inner surface of the second terminal.

4. The inductor of claim 1, wherein the horizontal connection portions comprise:
a plurality of upper horizontal connection portions connecting upper surfaces of the plurality of vertical connection portions; and
a plurality of lower horizontal connection portions connecting lower surfaces of the plurality of vertical connection portions.

5. The inductor of claim 1, wherein the vertical connection portions comprise:
a plurality of front vertical connection portions disposed at a front side of the body in a column direction; and
a plurality of rear vertical connection portions disposed at a rear side of the body in the column direction,
wherein when the front vertical connection portions are projected toward the rear vertical connection portions, the front vertical connection portions are located between the rear vertical connection portions.

6. The inductor of claim 5, wherein each of the upper horizontal connection portions connects any one front vertical connection portion among the plurality of front vertical connection portions and a rear vertical connection portion that is closest to the vertical connection portion among the plurality of rear vertical connection portions.

7. The inductor of claim 1, wherein a plurality of fine trenches extending in a vertical direction are provided on an outer circumferential surface of each of the plurality of vertical connection portions.

8. The inductor of claim 1, wherein the vertical connection portions and the horizontal connection portions have the same cross-sectional area.

9. The inductor of claim 8, wherein the vertical connection portions and the horizontal connection portions have a rectangular cross-section.

10. The inductor of claim 9, wherein the body is made of any one low dielectric constant material selected from the group consisting of silicon dioxide (SiO₂), cyclic olefin polymer (COP), fluorinated silicon oxide (SiOF), polyimides, parylene, fluorinated parylene, benzocyclobutene, and Teflon.

11. A manufacturing method of an inductor, the manufacturing method comprising:
a preparation step of preparing a mold made of an anodic aluminum oxide film;
a vertical through-hole forming step of forming a plurality of front vertical through-holes disposed at a front side of the mold in a column direction while penetrating upper and lower surfaces of the mold, and a plurality of rear vertical through-holes disposed at a rear side of the mold in the column direction while penetrating the upper and lower surfaces of the mold;
a vertical connection portion forming step of forming a plurality of front vertical connection portions and a plurality of rear vertical connection portions by filling each of the plurality of front vertical through-holes and the plurality of rear vertical through-holes with an electrically conductive material;
a horizontal connection portion forming step of forming a plurality of upper horizontal connection portions connecting upper surfaces of the plurality of front vertical connection portions and upper surfaces of the plurality of rear vertical connection portions at an upper side of the mold, and a plurality of lower horizontal connection portions connecting lower surfaces of the plurality of front vertical connection portions and lower surfaces of the plurality of rear vertical connection portions at a lower side of the mold;
a mold removing step of removing the mold so that only a coil part formed by connecting the plurality of front and rear vertical connection portions and the plurality of upper and lower horizontal connection portions remains; and
a body forming step of forming a body made of a low dielectric constant material and having the coil part embedded therein by entirely molding the coil part with a low dielectric constant material.

12. The manufacturing method of claim 11, wherein in the horizontal connection portion forming step, a first terminal connection portion connected to a horizontal connection portion located closest to a first end of the coil part among the plurality of horizontal connection portions and forming the first end of the coil part is formed, and a second terminal connection portion connected to a horizontal connection portion located closest to a second end of the coil part among the plurality of horizontal connection portions and forming the second end of the coil part is formed.

13. The manufacturing method of claim 12, further comprising, after the body forming step, a terminal forming step of forming the first terminal provided on a left surface of the body and electrically connected to the first terminal connection portion in a state in which a first end of the first terminal connection portion is in contact with an inner surface of the first terminal, and a second terminal provided on a right surface of the body and electrically connected to the second terminal connection portion in a state in which a second end of the second terminal connection portion is in contact with an inner surface of the second terminal.
